(19) United States
(12) Patent Application Publication
(10) Pub. No.: US 2021/0027382 A1
(43) Pub. Date: Jan. 28, 2021

(54) SYSTEM AND METHOD FOR MULTI-ACCOUNT TRACKING

(71) Applicant: ROYAL BANK OF CANADA, Toronto (CA)

(72) Inventors: Maximilian Benjamin Andreas NELTE, Bronxville, NY (US); Jonathan Christopher RUSSO, Jersey City, NJ (US); Scott William Martin PEDERSEN, Oakville (CA); Christopher James GALLANT, Brampton (CA)

(21) Appl. No.: 16/937,165

(22) Filed: Jul. 23, 2020

Related U.S. Application Data
(60) Provisional application No. 62/877,608, filed on Jul. 23, 2019.

(51) Int. Cl. G06Q 40/06; G06Q 40/02

(52) U.S. Cl. CPC G06Q 40/06; G06Q 40/02

(57) ABSTRACT

An account resource tracking system and method of tracking account resources are provided. The system comprises a processor and a memory storing instructions which when executed by the processor configure the processor to perform the method. The method comprises detecting an increase in resources associated with a first account, allocating a first portion of the increase in resources to a second account, determining a maximum resource tolerance amount of a remainder of the increase in resources to allocate to the first account, reallocating the remainder of the remainder of the increase in resources up to the maximum resource tolerance amount into the first account, determining an excess amount of the remainder that is over the maximum resource tolerance, and allocating the excess amount to the second account.

### CROSS REFERENCE TO RELATED APPLICATIONS

This application is a non-provisional of, and claims all benefit, including priority to U.S. Application No. 62/877,608, dated 23 Jul. 2019, entitled SYSTEM AND METHOD FOR MULTI-ACCOUNT TRACKING, incorporated herein in its entirety by reference.

### FIELD

The present disclosure generally relates to the field of tracking account resources, and in particular to a system and method for multi-account tracking.

### INTRODUCTION

Allocation of resources such as memory, network resources and even investment funds may be tracked. Annuity and other investment systems may be tailored for one of an aggressive, moderate or safe strategies. Accounting systems may be set up to track and manage separate accounts. The investing term ‘call option” refers to a contract that provides an investor the right to purchase an asset at a specific price. A “European call option” refers to a contract that provides the investor the right to purchase an asset at a specific price at a specific time (e.g., the expiration date of the option. An “American call option” refers to a contract that provides the investor the right to purchase an asset at a specific price at any time prior to the expiration date of the option.

### SUMMARY

When resource usage is unpredictable, the allocation of such resources may be hedged based on a maximum resource tolerance. For example, if memory (or other network resource) usage is increasing in a first account, resources may be allocated to a second account to prevent over exposure of resources in the first account. Another area where account resource tracking of resource allocation is helpful involves hedging investment funds.

In accordance with an aspect, there is provided an account resource tracking system. The system comprises a processor and a memory storing instructions which when executed by the processor configure the processor to detect an increase in resources associated with a first account, allocate a first portion of the increase in resources to a second account, determine a maximum resource tolerance amount of a remainder of the increase in resources to allocate to the first account, reallocate the remainder of the remainder of the increase in resources up to the maximum resource tolerance amount into the first account, determine an excess amount of the remainder that is over the maximum resource tolerance, and allocate the excess amount to the second account.

In accordance with another aspect, there is provided another account resource tracking system. The system comprises a processor and a memory storing instructions which when executed by the processor configure the processor to determine a gain from a first account, transfer a fixed percentage of the gain from the first account to a second account, determine an excess amount, and transfer the excess amount from the first account to the second account.

In accordance with another aspect, there is provided another account resource tracking system. The system comprises a processor and a memory storing instructions which when executed by the processor configure the processor to determine a gain from a first investment account, transfer a first portion of the gain from the first investment account to a second investment account, determine a maximum participation amount of a remainder of the gain to reinvest in the first investment account, reinvest the remainder of the gain up to the maximum participation amount into the first investment account, determine an excess amount of the remainder that is over the maximum participation amount to the second investment account, and transfer the excess amount from the first investment account to the second investment account.

In accordance with another aspect, there is provided a method of tracking account resources. The method comprises detecting an increase in resources associated with a first account, allocating a first portion of the increase in resources to a second account, determining a maximum resource tolerance amount of a remainder of the increase in resources to allocate to the first account, reallocating the remainder of the remainder of the increase in resources up to the maximum resource tolerance amount into the first account, determining an excess amount of the remainder that is over the maximum resource tolerance, and allocating the excess amount to the second account.

In accordance with another aspect, there is provided another method of tracking account resources. The method comprises determining a gain from a first account, transferring a fixed percentage of the gain from the first account to a second account, determining an excess amount, and transferring the excess amount from the first account to the second account.

In accordance with another aspect, there is provided another method of tracking account resources. The method comprises determining a gain from a first investment account, transferring a first portion of the gain from the first investment account to a second investment account, determining a maximum participation amount of a remainder of the gain to reinvest in the first investment account, reinvesting the remainder of the gain up to the maximum participation amount into the first investment account, determining an excess amount of the remainder that is over the maximum participation amount to the second investment account, and transferring the excess amount from the first investment account to the second investment account

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates an example of a common fixed index annuity mechanism;

FIG. 2A illustrates, in a component diagram, an example of an account resource tracking system, in accordance with some embodiments;

FIG. 2B illustrates, in a component diagram, another example of an account resource tracking system, in accordance with some embodiments;

FIG. 2C illustrates, in a component diagram, another example of an account resource tracking system, in accordance with some embodiments;

FIG. 2D illustrates, in a component diagram, another example of an account resource tracking system, in accordance with some embodiments;

FIG. 3A illustrates, in a flowchart, an example of a method of tracking multiple accounts, in accordance with some embodiments;

FIG. 3B illustrates, in a flowchart, another example of a method of tracking multiple accounts, in accordance with some embodiments;

FIG. 3C illustrates, in a flowchart, another example of a method of tracking multiple accounts, in accordance with some embodiments;

FIG. 3D illustrates, in a flowchart, another example of a method of tracking multiple accounts, in accordance with some embodiments;

FIG. 4 illustrates an example of a multiple account resource tracking mechanism, in accordance with some embodiments;

FIG. 5 illustrates another example of a multiple account resource tracking mechanism, in accordance with some embodiments;

FIG. 6 illustrates, in a flowchart, an example of a method of tracking investment accounts, in accordance with some embodiments; and

FIG. 7 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings.

Resource allocation in accounts may be tracked. For example, a first account may be allocated resources (e.g., memory, network resources, funds, etc.) for usage. Should the amount of resources increase (used or required) then a portion (resource or usage) could be transferred to a second account. When resource usage is unpredictable, the allocation of such resources may be hedged based on a maximum resource tolerance. For example, if memory (or other network resource) usage is increasing in a first account, resources may be allocated to a second account to prevent over exposure of resources in the first account. Another example for where account tracing of resource allocation is helpful is for hedge investment funds.

Tracking annuity and other investment systems tailored for mixed strategy methodologies can be complex enough when all information is available prior to a purchase or sale of an asset. However, the complexity significantly increases when orders for a large volume of purchase or sell decisions need to be made in advance of a deadline. For example, in a European call option, the option may expire at the end of the business day of a term. However, the order to purchase/renew the investment may be due at least one hour prior.

For insurance providers, or other entities that provide investment related products, determining a maximum aggregate exposure for policy or other product hedging utilizing European call options may require additional information from different systems. For example, hedging of fixed index annuity or variable annuity policies may change based upon information about the policy holder or their decisions. Such insurance policies may be surrendered or newly added. Such information change can affect the amount of hedge purchases to order. When such changes occur between the deadline to make a purchase order and the execution of the order itself (e.g., for European call options), then estimates need to be made. Additionally, there could also be changes in the value of the index or other component to be hedged between the time the order was placed and the time the order is processed. Since the magnitude of policy or product exposure to be hedged may be significant and change based upon multiple variables, it is important to have as accurate an estimate of proper hedge purchase as possible at the hedging order cut off time in order to minimize any risk to which the insurer is exposed as a result of otherwise unanticipated deviations to the theoretically proper hedge purchase calculations. Such issues, and techniques and systems to mitigate such issues, will be described further below.

In some embodiments, a process to track insurance contract crediting rates among a system of accounts with mixed crediting methodologies is provided.

In some embodiments, a process to convert and track non-credited account values to credited account values is provided.

In some embodiments, a process to limit aggregate investment exposure among accounts and/or sub-accounts of differing crediting methodologies is provided.

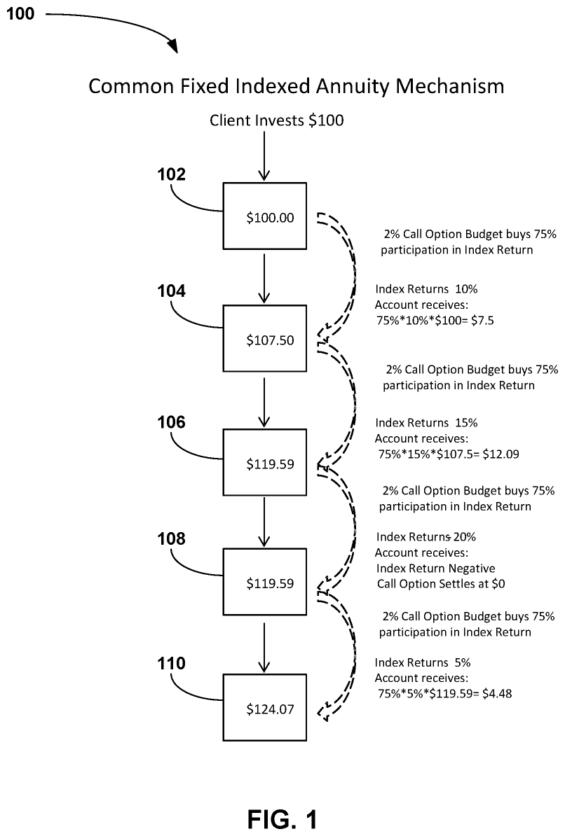

FIG. 1 illustrates an example of a common fixed index annuity mechanism 100. In the example shown, a 2% yield on the account value each year is provided for an option investment in an index, or alternatively an index fund or other asset. In the example shown, the 2% option budget provides an option for 75% participation in the upside of the index given the current account value size. Once a value is credited to the account, it can never be lost (i.e., in the event of a market drop, the client's account does not go down. This locked-in amount is known as the credited account value.

In the example of FIG. 1, a client may initially invest $100 at the start of the first period of time (e.g., year) 102. The 2% call option budget buys 75% participation in an index return. If, at the end of the term, the index returns 10%, then the client's account receives 75%*10%*$100=$7.50. As such, the account value at the start of the next term 104 is $107.50 and the 2% call option budget buys 75% participation in the index return. At the end of the second period of time (e.g., year) 104, the index returns 15%, and the client's account receives 75%*15%*$107.50=$12.09. As such, the account value increases to $119.59 for start of the third term 106 and the 2% call option budget buys 75% participation in the index return. At the end of the third period of time 106, the index returns −20%. Since the index return is negative, the call option settles at $0. As such, the account value at the start of the next period of time 108 remains at $119.59 and the 2% call option budget buys 75% participation in the index return. During the fourth period of time 108, the index returns 5%, and the client's account receives 75%*5%*$119.59=$4.48. As such, the client account value is $124.07 at the start of the next period of time 110.

In some embodiments, multiple investment accounts may be used in combination for an investment process where a crediting methodology may be applied to transfer funds from a first account, sub-account or logical account to a second account, sub-account or logical account. A material portion in annual policy gains may be directly re-invested in an index upon each anniversary date rather than only a fraction of such gains corresponding to interest rate yields for standard products. As such, the amount of option hedge required for such policies by annuity writers can be material in size and vary substantially based upon last minute movements in the index and thus need to be estimated accurately in order to prevent or at least mitigate risks and expenses of over or under hedging.

In some embodiments, the crediting methodology requires monitoring and implementation of a maximum option exposure level which is triggered based upon overall policy value in combination with concurrent index gains versus the prior year. Such maximum option exposure level may be predetermined and the overall policy value and actual annual index gains may be determined at the end of each policy anniversary (typically at 4 pm on the last day of the policy term). New and timely information should be utilized to determine the proper maximum limit to the hedge amount to be purchased prior to the end of day on each anniversary.

The final overall policy market value and its current year gains are only known at or after the close on the anniversary date (e.g., at or after 4 pm on the anniversary date). However, reinvestment decisions and orders must be made prior to the close in order for the reinvestment (or new investment) purchases to be made at that close. Therefore, accurate and timely estimation of hedge purchase amounts are to be performed before the close in order to ensure hedge orders are made on a timely and accurate basis. In fact, such estimates should be available well before the close to meet trading cut off times, e.g., 2:30 pm or 3 pm in order for the orders to be processed prior to the 4 pm closing time.

Since policy re-investments via option hedges may be substantial compared to other crediting methods, ensuring non-market policy data is as up to date as possible immediately before an annual hedging decision is made can be critical.

Annuity policy and valuation administration systems generally work on a singular end of day batch basis because final market values, client policy matters and related information are available and effective at the end of the business day. However, each of the above challenges require accurate and up to date market, policy and/or policy holder information as soon as practical before a trading cut off time prior to a 4 pm close, e.g., by 3 pm.

In order to adapt administration systems to these challenges, new combinations of additional batch processing/procedures, together with a live ticking hedge estimation system, could be implemented to support the new credited methodology.

In some embodiments, an early additional close of policy data, market/valuation data and other related critical information could be implemented prior to the trading cut off. The implementation and usage of this early batch data close could entail addressing two competing issues: i) timing the batch data close early enough to ensure the data is available for trading cut off without fail, vs ii) allowing for the most accurate data by waiting to as close to the trading time (e.g., 3 pm) as possible to complete the batch.

Timing the batch data close early enough to ensure the data is available for trading cut off without fail may entail targeting an early batch data close at an earlier time (e.g., 1 pm) in order to prepare for a 3 pm trading time for which the processed data is required. Timing buffers between the early batch data close and the trading cut off should allow for:
The receipt, from several systems, of the most recent data such as surrenders, mortality, policy holder investment choice changes, current policy investment terms, policy valuation, gains and index market levels.
Time to ensure quality checks, reconciliations and needed corrections of the batch data close which may require manual intervention.
Potential time to re-run the batch close if a system fails or reconciliations/corrections require it. The batch may take a material amount of time to re-run such as 1 hour. Accordingly, a time buffer should be built in between an initial early batch close and the trading cut off in order to permit a backup batch run and related reconciliation, if needed.
A new “early fast-close” process may be segregated, streamlined and adapted from the normal close processing in order to a) meet the processing window by targeting only the necessary valuation and reconciliation; and b) allow for possible implementation of, and reporting from, a “shadow” book of values to avoid adverse impacts to the normal close processing and allow for faster repetitions.

In order to allow for the most accurate data indicates waiting to as close to the 3 pm trading time as possible to complete the batch. In order to address this challenge, the results of the early batch (e.g., 1 pm batch) data can then be supplemented with a purpose built on-the-fly hedge amount estimation system which utilizes early batch close policy information combined with ticking index data to determine current (e.g., up-to-the-minute) estimated required hedging levels until needed at the 3 pm trading cut off. Critically, this system would combine aggregate policy terms/data from the early batch with continuous live index data to determine the dynamic value of the existing option hedge gains and the aggregate policy value in order to determine the amount of new option hedge investment from both an absolute size perspective as well as controlling the maximum exposure permitted in the crediting strategy.

Additional analytics could discover specific “volatility factors” that would i) identify inputs that have higher than average impact to the hedge calculations (e.g., secondary option pricing factors such as volatility, interest rates or dividends, overall participation vs price variance, surrender/mortality within projected range, etc.), and ii) actively report on and track current positioning of those volatility factors within their banded expectations (i.e., as expected, nearing upper/lower limits, etc.) to help establish confidence levels in hedging levels.

In some embodiments, a one year European Call Option on a volatility target index implemented point-to-point over a multi-year period may be used. In some embodiments, a current implementation utilizes a 60/40 Index with a 5% or a 6% volatility target used in 1 year at the money (ATM) call options implemented each year for a 10 year period. It is understood that other combinations of financial options, yield percentages, indices, timelines and periods may be used. In addition, for a portion of overall future hedging needs, it is contemplated that on day one the client may in fact purchase a strip of forward starting options via locked in pricing, i.e., fixed payments to be made each year by the client in exchange for the forward starting options. The overall construct is described below.

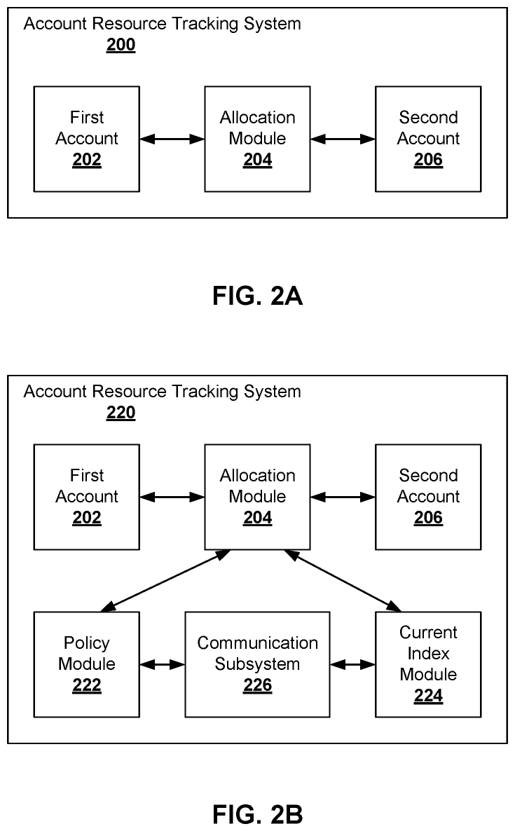

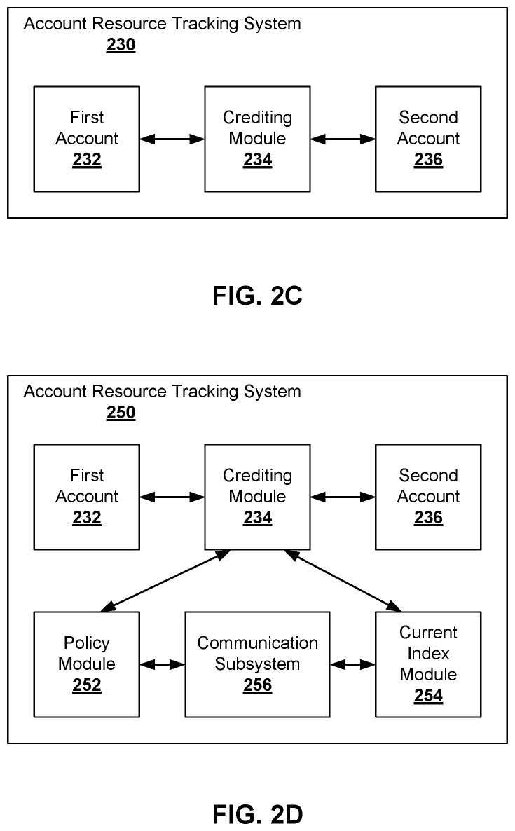

FIG. 2A illustrates, in a component diagram, an example of an account resource tracking system 200, in accordance with some embodiments. The account resource tracking system 200 comprises a first account 202, a second account 206 and an allocation module 204. The first account 202 is the account (or sub-account or logical account) where all or the bulk of initial resource allocation is made. The second account 206 (or sub-account or logical account) may comprise an account that generally starts with no or smaller allocation of initial resources. During the life of the account 206, it receives a portion of increase in resources from the first account 202. Each term (e.g., year) based upon any resources in the second account 206, the second account 206 uses resources based upon its resource allocation. Any increase in resources from the second account 206 stay solely in the second account 206. The crediting module 204 comprises logic to determine when to allocate resources from the first account 202 to the second account 206. Other components may be added to the system 200.

FIG. 2B illustrates, in a component diagram, another example of an account resource tracking system 220, in accordance with some embodiments. The account resource tracking system 220 includes the first account 202, the second account 206, the allocation module 204, a policy module 222 for receiving policy updates, a current resource allocation index module 224 for receiving up-to-date resource allocation metrics, and a communication subsystem 226 for communicating with external systems to obtain policy and/or current resource allocation information. Other components may be added to the system 220.

FIG. 2C illustrates, in a component diagram, an example of an account resource tracking system 230, in accordance with some embodiments. The account resource tracking system 230 comprises a first account 232, a second account 236 and a crediting module 234. The first account 232 is the account (or sub-account or logical account) where all or the bulk of initial product investment is made. This initial account balance is never subject to loss because only its standard option budget and a direct portion of past option gains are invested into an option premium for the coming year or term. In some embodiments, such direct portion of option gains re-invested in premium options may be subject to a global cap based upon the credited value of the two accounts, i.e., account values less outstanding option premium/option value. The second account 236 (or sub-account or logical account) may comprise a fixed index annuity (FIA) that generally starts with no or smaller amounts of initial investment. During the life of the account 236, it receives a portion of option wins achieved by the first account 232. Each term (e.g., year) based upon any monies in the second account 236, the second account 236 invests in option premium based upon its option budget. Any option gains from the second account 236 stay solely in the second account 236. Since the second account 236 only invests from option budget and does not disburse funds elsewhere, once monies are deposited in the standard FIA (e.g., second account 236), they are never subject to loss. Alternatively, the second account 236 could be a simple interest bearing account which stores the value of gains from the first account 232 strategy. The crediting module 234 comprises logic to determine when to transfer gains from the first account 232 to the second account 236. Other components may be added to the system 230.

The account resource tracking system 230 may be used in multiple stages to track multiple investment accounts. In particular, there may be an initial stage and an investment process. During the initial stage:
$X is initially invested
$X*Y %=$First is added to the first account 232—where Y % is often expected to be 100%, but can be any percentage between 0 and 100.
$X*(1−Y %)=$Second is added to the second account 236

In some embodiments, money in each account has an option budget of A %, e.g., 2%-3%. This amount may be generated based upon the bond investment portfolios (e.g., of an insurance company) target return rate for balances less various expenses. In that way, it can be viewed as coming externally from the program while account balances earn no interest. In some embodiments, the option budget may comprise a yield of bonds (e.g., US bonds) such as between 2 and 4%. It is understood that if rates rise, so too may the option budget. It should also be understood that any pre-determined percentage may be use for the option budget, and that different accounts may have different budget options based upon various market indicia or alternative policy terms.

The investment process comprises a first account 232 process and a second account 220 process. At the inception of each year of the program, the second account 236 (e.g., a fixed income account) has an option budget of A % of its balance. Accordingly, $Second*A % of one year at the money European Call Options may be purchased for the second account 236. It is understood that a different option budget may be used in the second account 236 than the first account 232. Any “wins” or gains on the options purchased are placed in the second account 236 and future options are purchased based upon the second account's option budget. Although monies in the second account 236 are not removed (other than annuity holder reallocations), periodically monies from first account 232 option “wins” or gains are added as described below.

At the inception of each year of the program, the first account 232 invests in option premium equal to a standard option budget of the account plus a portion of the prior year's option gain in the first account 232. The standard option budget of the account which is the current $First*A %, i.e., where $First does not include account value gains directly re-invested into options. It should be noted that since the first account 232 does not re-invest option wins or gains into itself in a guaranteed manner, but only either applies the money directly to option purchases or is transferred the to the second account 236, the base account value remains the same and the option budget is the same every year other than due to variations in A %, e.g. changes in interest rates or various policy related expenses. It should also be noted that to be purchased option premium, or initial option value, may be considered when calculating option budget. For example, the option purchases may be limited by maximum exposure calculations, which in some embodiments include the option value in the overall account value rather than just the guaranteed account values that may be utilized in other embodiments.

In some embodiments, the portion of the prior year's option win to be re-invested in the first account 232 is set to 50%. I.e., 50% of the first account 232 win or gains is re-invested directly in one year options for the coming year for the benefit of the first account 232. It should be understood that another percentage of the prior year's option win may be divided between the first account 232 and the second account 236 (e.g., 60/40, 35/65, or any other percentage split). The remainder is transferred to the second account 236 and option premium is purchased based upon the option budget for that year and future years. To the extent that the aggregate account program's Participation Rate in all options (first account 232 plus second account 236) exceeds the Maximum Participation Rate, e.g., 300% or 400%, then the ratio of option wins transferred to the second account 236 is increased to the extent that the Participation Rate is equal to the Maximum Participation Rate. In some embodiments, the Participation Rate is equal to the aggregate notional of options (i.e., the dollar value of the reference number of index units referenced) divided by the Total Credited Account Value of the total account program. In some embodiments, the Total Credited Account Value is equal to the (A) total value of (i) first account 232 plus (ii) the second account 236, (B) less any option value, option premium bought or to be bought based upon the option budget and the direct option win option purchases. In some embodiments, the Maximum Participation Rate is based upon the Total Account Value (e.g., the aggregate value of the first account 232 and second account 236) rather than fully credited account values.

FIG. 2D illustrates, in a component diagram, another example of an account resource tracking system 250, in accordance with some embodiments. The account resource tracking system 250 includes the first account 232, the second account 236, the crediting module 234, a policy module 252 for receiving policy updates, a current index module 254 for receiving up-to-date index valuations, and a communication subsystem 256 for communicating with external systems to obtain policy and/or current index information such as surrenders, mortality, policy holder investment choice changes, current policy investment terms, policy valuation, gains, index levels and other market data. Other components may be added to the system 250.

In some embodiments, the policy module 252 may be used to obtain (e.g., receive or request) updated information regarding one or more policies. Such updated information may indicate changes to policies that may affect values or participation in an index. For example, policy holders may choose to change investment choices, annuitize or life events may cause a termination in the policy. Such updated information may be used to determine a policy holder's participation (or continued participation) in an index at the start of the next period. Such updated information could also be used to modify risk tolerance and/or index hedge selections at the start of the next period. In some embodiments, modifications to participation in different indexes (including modifications to purchase order requests) may be automated based on the updated information.

In some embodiments, the current index module 254 may obtain (i.e., receive and/or request) regular ticking index data. Purchase decisions may be made and/or adjusted using the updated index data. For example, a maximum participation amount may change based on updated index data. In some embodiments, modifications to participation in an index (including modifications to purchases order requests) may be automated based on the updated index data.

In some embodiments, updated index data may be utilized in combination with a pre-calculated “what if” numerical solution participation scenario vector that has calculated potential total index dollar participation amounts based upon multiple potential index levels versus up to date policy level details such as participation maximums, prior account gains and various policy riders. The availability of the pre-calculated index level vs dollar index participation sensitivity vector enables the system to dynamically adjust index hedge estimates without having to re-access policy systems data and re-perform detailed calculations involving policies that vary in nature by vintage and multiple policy terms and may require numerical solution methods. For example, predetermined hypothetical purchase order requests may be prepared at an early close and associated with a scenario vector (e.g., possible percentage change in index level between early close and the time of purchase). Therefore, when index information is updated near the actual purchase order time prior to the actual close, then the purchase order selection may be automated based on the received updated index information. As such, the use of the system 250 allows for numerous complex purchase orders for different policy holders to be made and/or modified shortly before purchase time in a manner that mitigates the overall hedge sizing risk for the hedging entity (e.g., insurance company).

In some embodiments, the communication subsystem 256 may comprise communication means between a server hosting the account resource tracking system 250 and servers hosting policy data and/or index data. The communication subsystem 256 may also be used to communicate with servers hosting index purchase order systems. In some embodiments, the account resource tracking system 250 may include scheduling logic to automatically place or modify purchase orders via the communication subsystem 256. Larger purchase orders may be divided into batches and sent to the same or different index participation providers, in part based upon pricing and credit risk considerations.

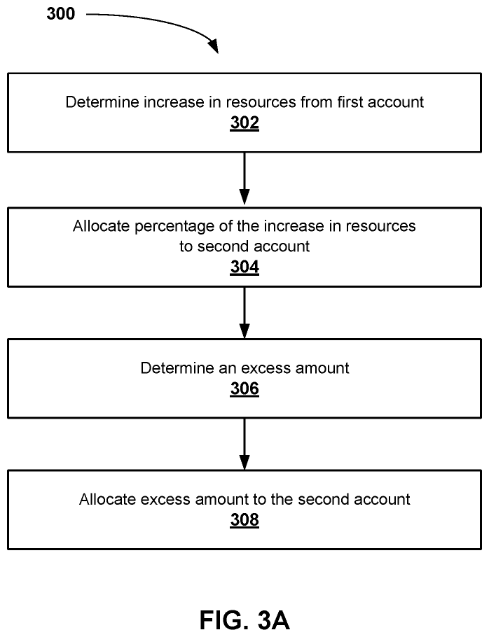

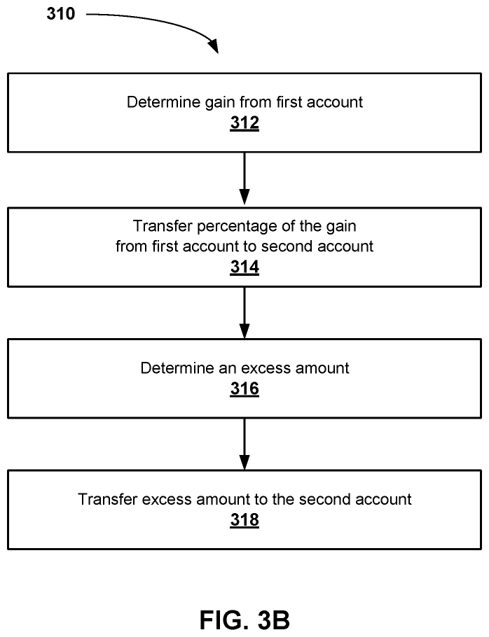

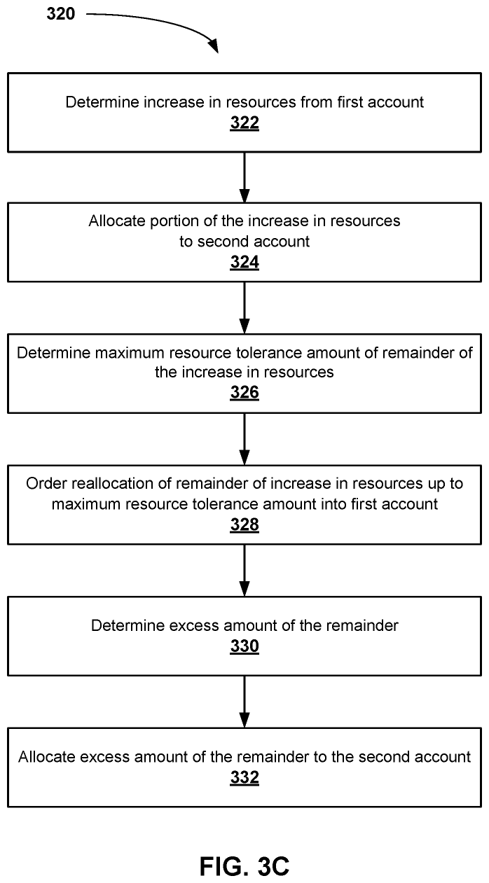

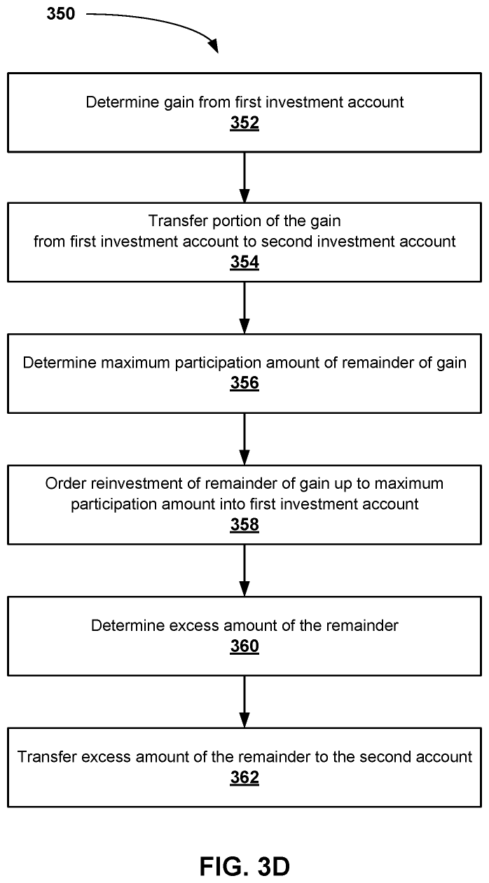

FIG. 3A illustrates, in a flowchart, an example of a method of tracking multiple accounts 300, in accordance with some embodiments. The method 300 comprises determining 302 a gain from a first account 202. Next, a fixed percentage of the gain from the first account 202 is transferred 304 to a second account 206. Next, an excess amount is determined 306. This excess amount is also transferred 308 from the first account to the second account 206. Other steps may be added to the method 300, including determining a total value of the first and second accounts.

FIG. 3B illustrates, in a flowchart, an example of a method of tracking multiple accounts 310, in accordance with some embodiments. The method 310 comprises determining 312 a gain from a first account 232. Next, a fixed percentage of the gain from the first account 232 is transferred 314 to a second account 236. Next, an excess amount is determined 316. This excess amount is also transferred 318 from the first account to the second account 236. Other steps may be added to the method 310, including determining a total value of the first and second accounts.

In some embodiments, determining 312 the gain from the first account 232 comprises determining an option budget and a corresponding participation rate at the beginning of a time period combined with index return data as of the end of a time period a year later. An initial and/or minimal option budget may be set to a percentage of the value of the first account 232 to buy into the corresponding participation rate for the index return. For example, the first account 232 may have an initial investment amount of $100 with a 2% call option budget that may be used to buy 75% participation in the index return. The gain from the first account 232 may be determined based on an actual return at the end of a period of time (e.g., year) of the index term. For example, if the index returns 10%, at a participation of 75%, the gain would be 75%*10%*$100=$7.50.

In some embodiments, the fixed percentage of the gain may be 50%. As such, 50% of $7.50 or $3.75 would be transferred to the second account 236. The remainder of the gain may be transferred to another account or added to the premium budget.

In some embodiments, the account resource tracking system 230 may comprise a combination aggressive and conservative investment tracking and crediting apparatus, including an aggressive combination fixed income and option investment account and a conservative fixed income investment account. It should be understood that the options themselves may comprise equity-based or mixed asset classes such as equity, fixed income and possibly commodities. The combination fixed income and option account generates returns and stores a portion of the returns for re-investment based upon certain account return metrics. The conservative account generates fixed income returns on its balances. The tracking and control apparatus is designed to transfer a dynamic amount of funds from the aggressive account to the conservative account when the tracking system measures that certain aggressive account performance metrics have been met. The tracking and crediting apparatus is controlled to give priority to limiting the overall exposure of the two accounts to aggressive investments. This is accomplished by enabling the transfer of additional funds from the aggressive account to the conservative account to the extent that the apparatus detects that the overall exposure to the underlying of the aggressive account would exceed prescribed limits when compared to the size of the combined accounts. When the apparatus determines that such limits would be breached, the crediting process of funds to the aggressive account would be disabled for any such amounts that would cause the breach until such excess is otherwise alleviated.

FIG. 3C illustrates, in a flowchart, another example of a method of tracking multiple accounts 320, in accordance with some embodiments. The method 320 comprises detecting 322 an increase in resources from a first account 202. Next, a portion of the increase in resources from the first account 202 is transferred 324 to a second account 206. Next, a maximum resource tolerance amount of a remainder of the increase in resources to reallocate in the first account is determined 326. Next, a reallocation of the remainder of the increase in resources up to the maximum resource tolerance amount into the first account is made 328. Next, an excess amount of the remainder is determined 330. This excess amount is also allocated 332 from the first account to the second account 206. Other steps may be added to the method 320, including determining a total value of the first and second accounts, obtaining updated policy information regarding the first account, obtaining updated resource allocation index values for the resources associated with the accounts 202, 206, and recalibrating the estimated increase in resources, remainder and excess amounts based on the updated information.

FIG. 3D illustrates, in a flowchart, another example of a method of tracking multiple accounts 350, in accordance with some embodiments. The method 350 comprises determining 352 a gain from a first investment account 232. Next, a portion of the gain from the first investment account 232 is transferred 354 to a second investment account 236. Next, a maximum participation amount of a remainder of the gain to reinvest in the first investment account is determined 356. In some embodiments, the maximum participation amount is defined such that reference underlying exposure of the option investments do not represent more than an amount (say, 300%) of A) a total account value or B) a guaranteed credited account value. Next, an order to reinvest the remainder of the gain up to the maximum participation amount into the first account is made 358, where A) may require custom development of numerical solution methods in order to resolve the proper excess amount 360. In some embodiments, the maximum participation amount is defined such that reference underlying exposure of the option investments include A) options to be purchased in account 232 or B) all options to be purchased in accounts 232 and 236. Next, an excess amount of the remainder is determined 360. This excess amount is also transferred 362 from the first investment account to the second investment account 236. Other steps may be added to the method 350, including determining a total value of the first and second accounts, obtaining updated policy information regarding the first investment account, obtaining updated index market rates for the investment associated with the investment accounts 232, 236, and recalibrating the estimated gains, remainder and excess amounts based on the updated obtained updated policy information and updated index market rates.

The examples below are described using hedge funding as the application for the system and method where the terms “gain” and “maximum participation amount” are used. It should be understood that these terms are included in the terms “increase in resources” and “maximum resource tolerance amount”. It should be understood that the teachings may be modified to apply to other resources that are tracked in accounts.

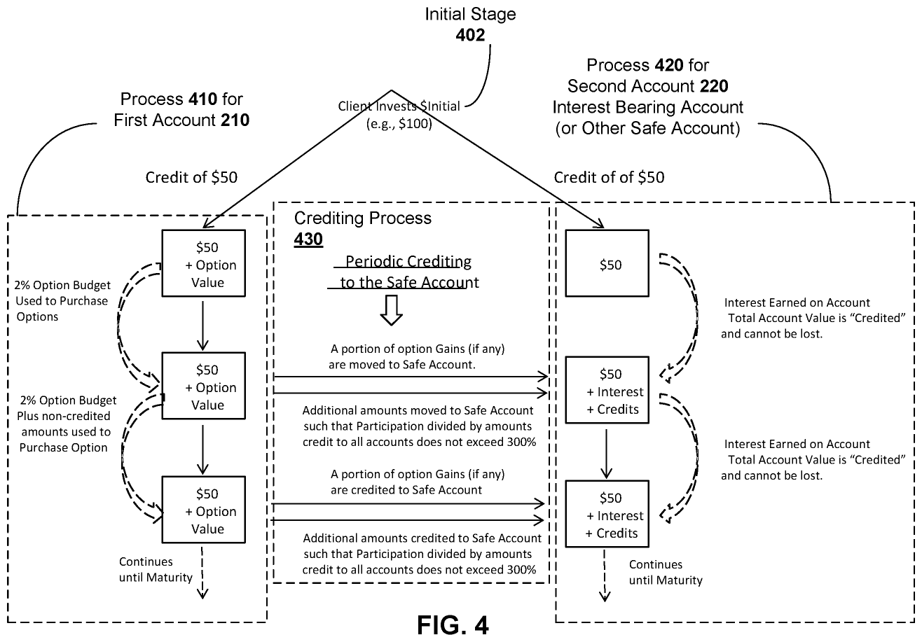

FIG. 4 illustrates an example of a multiple account resource tracking mechanism 400, in accordance with some embodiments. The mechanism 400 includes an initial stage 402, a first investment process 410 for a first account 232, a second investment process 420 second account 236, and a crediting process 430. Other accounts and crediting processes may be added to the mechanism 400.

During the initial state, an amount ($lnitial) is received as an initial investment. In some embodiments, the entire $Initial may be transferred to the first account 232. In other embodiments, a portion of the $Initial may be transferred to the first account 232 and the remainder to the second account 236 (or distributed amongst all accounts if more than two accounts are included in the mechanism). In the example of FIG. 4, 50% (e.g., $50) of an initial investment (e.g., $100) is placed in the first account 232 and the remainder in the second account 236.

The first investment process 410 may be set up to provide a percentage option budget (OB %) used to purchase options. In some embodiments, the OB % may be initially set to 2% (or another default amount). At the end of the first period of time (e.g., year) the options will yield a result or gain ($G) from the $Initial investment. A portion of that gain ($OG), if any, will be added to the OB % while the remainder of the gain ($CG) will be credited to the second account 236. If the result is a negative yield, then the gain is set to $0. It should be understood that in other embodiments, the gain for a negative yield could be set to an arbitrary value and/or a negative value (i.e., loss). The first investment process 410 continues until maturity.

The crediting process 430 provides periodic crediting of amounts from the first account 232 to the second account 236. In some embodiments, the second account is a “safe” account (such as an interest bearing account or other account that is a “safer” account than the first account 232). The crediting module 234 will determine/estimate the $OG and $CG due at the end of the crediting process 430. In some embodiments, the crediting module 234 may also determine an additional amount from the $G to credit to the second account 236 in order to prevent the OB % from passing a maximum amount. In some embodiments, investment participation is limited by converting what would otherwise be first account 232 option premium investments into credited second account 236 investments by transferring such value into the second account 236. In some embodiments, participation divided by amounts credited to all account is capped at 300% or 400%. I.e., the maximum option value (i.e., OB %) to purchase options is capped at 300% or 400%. It should be understood that participation may be capped at different percentages.

The second investment process 420 may be set up to provide interest based upon current market rates less expenses or the previous period's investment in a fund or portfolio of bonds, and to receive credited amounts from the first investment process 410. Credited account values for the second account 236 may be set to the total aggregate of the account value for the second account 236 at the end of the previous period of time, the interest gained at the end of the current period of time, and the amount credited from the first account 232 at the end of the current period of time. Interest earned on total account value is “credited” and cannot be lost. Total account value includes all credited amounts and all non-credited amounts. All credited amounts comprise the total credited value. The second investment process 420 continues until maturity.

As such, a process to track insurance contract crediting rates among a system of accounts with mixed crediting methodologies may be provided. A process to convert and track non-credited account values to credited account values may also be provided. A process to limit aggregate investment exposure among accounts and/or sub-accounts of differing crediting methodologies may also be provided. In aggregate, these processes facilitate the co-existence of combinations of aggressive, moderate and/or conservative investment strategies in one package for fixed index annuity investors with the safeties associated with periodic crediting rates and provides the insurance company with the methodologies to track the crediting process and track overall participation.

It should be noted that typical accounting systems add option gains only to credited account values, keep account value and credited account value separate, and would need to add a solution for maximum exposure tracking across accounts. In contrast, the multiple account resource tracking mechanism described herein tracks the difference between account value and credited account value, and includes a mechanism (optional) for maximum exposure tracking across accounts.

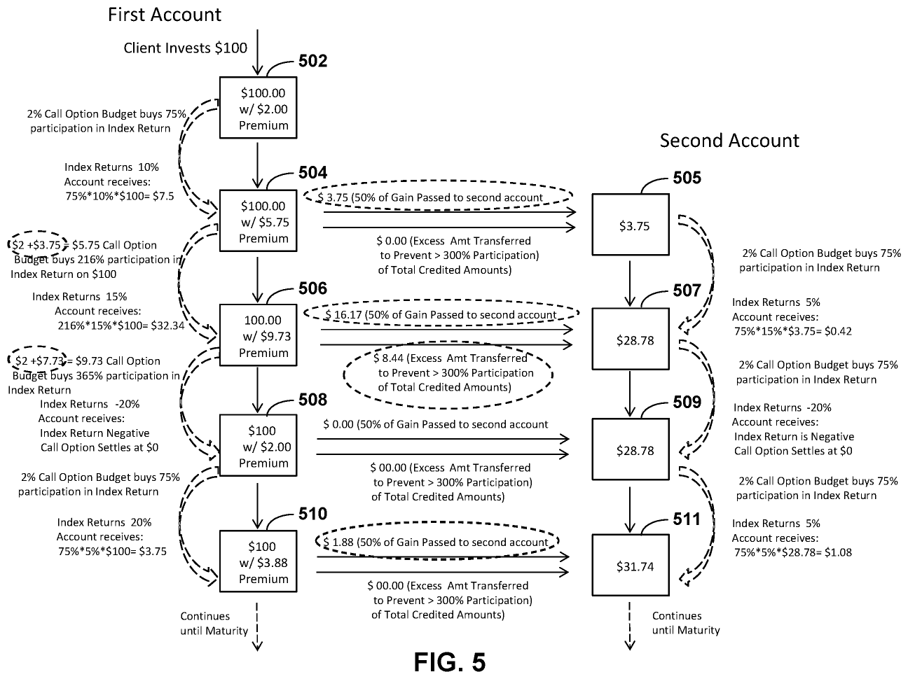

FIG. 5 illustrates another example of a multiple account resource tracking mechanism 500, in accordance with some embodiments. In the example shown, a 2% yield on the account value each year is provided for an option investment in an index. In the example shown, the 2% option budget provides an option for 75% participation in the upside of the index given the current account value size. Once a value is credited, to the second account 220, it can never be lost. Additionally, the original investment (e.g., $100) can never be lost.

In the example of FIG. 5, a client may initially invest $100 in the first account 232 at the start of the first period of time (e.g., year) 502. The 2% call option budget buys 75% participation in an index return. If the index returns 10%, then the first account 210 gains 75%*10%*$100=$7.50. 50% of this amount ($3.75) is transferred or credited to the second account 236 which is used as an initial investment in the second account 236. I.e., a portion of the gain is protected by being credited to the second account 236 and cannot be lost. The second account 236 value is $3.75 at the start of the second period of time (e.g., year) 505. The other 50% ($3.75) is added to the call option budget. For example, with a value of $100, the 2% call option budget is $2. Adding half of the first account 232 gain to the call option budget provides for $5.75 as the total call option budget at the start of the second period of time 504. As the call option budget increased, so too did the participation rate. In this case the participation rate is increased at the same percentage increase as the call option budget (i.e., from 75% to 216%). I.e., a portion of the option gains are used to directly purchase more premium rather than credited second account 236 value.

The first account 232 value in the second period of time 504 is $100 with a $5.75 call option budget that buys approximately 216% (215.625%, i.e., proportional to 2% buying 75%) participation in the index return. At the end of the second period of time 504, if the index returns 15%, then first account 232 gains 216%*15%*$100=$32.34. 50% of this amount ($16.17) is transferred to the second account 236. The other 50% could be added to the call option budget for a total call option budget of $18.17 at the start of the third period of time 506. In some embodiments, participation in the index may be capped. I.e., a maximum participation rate is provided to prevent too much exposure for account holders on the index or too much option hedging requirement for the insurance company, while ensuring that substantial portions of very large gains are protected. In the example of FIG. 5, the cap is set to 300% of participation of total credited amounts (i.e., globally on all accounts). Therefore, at the start of this period of time in this example, the option premium for account 210 is capped at 300%*$128.78*2%/75%−2%*$28.78=$9.73. As such, only $7.73 of the gain at the end of the second period of time 504 is added to the premium which would become $9.73 that buys 365% participation within account 232. The remaining $8.44 may be transferred to the second account 236 as an excess amount transferred to prevent greater than 300% investment participation of credited amounts on average across both accounts.

The second account 236 value at the start of the second period of time 505 was $3.75. The second account 236 may participate in the same or a different index or different investment reference item. In the example of FIG. 5, both first and second accounts participate in the same index with the second account 236 having a constant 2% call option budget for 75% of the index return. The same calculations may be performed for the second account 236 at the start of the second period of time 505. Here, the second account 236 gains 75%*15%*$3.75=$0.42. This amount is added to the initial value of $3.75, 50% gain credit of $16.17, and the excess amount credit of $8.44 for a total of $28.78 as the second account 236 credited account value at the start of the third period of time 507.

In the example of FIG. 5, at the end of the third term 506, the index returns −20%. Since the index return is negative, the call option settles at $0 (i.e., no credits are added to the second account 236). The second account also has a call option referencing the negative return of the index and as such, the call option also settles at $0 (i.e., no value is gained). As such, the call option for the first account 232 at the start of the next period of time 508 reverts to the minimum $2 that buys 75% participation in the index return. It is noted that in this example, despite the market drop, the second account 236 does not go down. This locked in amount is known as the credited account value for that account.

In the example of FIG. 5, at the end of the fourth period of time 508, the index returns 5%, and the first account 232 gains amount 75%*5%*$100=$3.75. As such, the client credited account value is $100.00. 50% of the account 232 option gain amount (i.e., $1.88) is transferred or credited to the second account 236. The other 50% (i.e., $1.88) is added to the call option budget within the 232 account, providing for $3.88 as the total call option budget at the start of the next period of time 510 for the 232 account. The second account 236 value at the start of the fourth period of time 509 was $28.78. The second account 236 gained 75%*5%*$28.78=$1.08. This amount and the 50% gain credit are added to the second account 236 for a total of $31.74 as the second account 236 credited value for the start of the next period of time 511. The mechanism may continue until maturity.

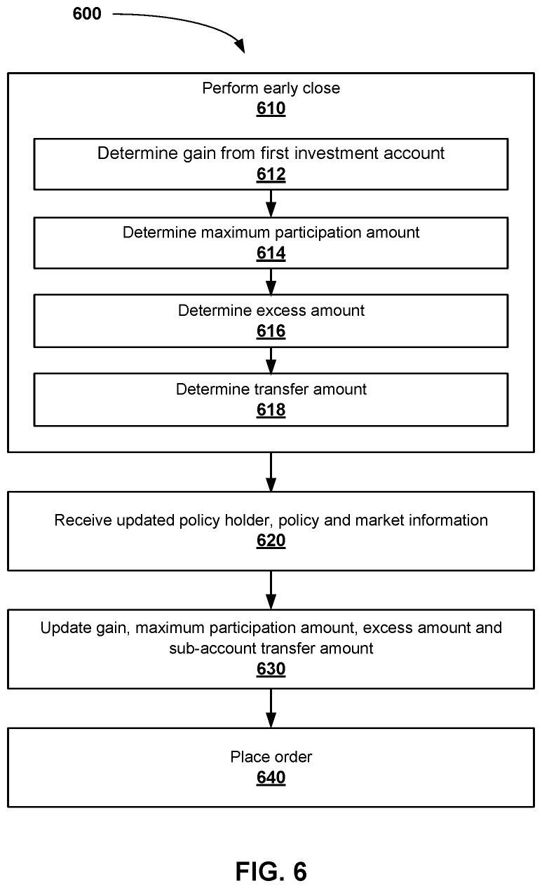

FIG. 6 illustrates, in a flowchart, an example of a method of tracking investment accounts for mixed investment methodologies 600, in accordance with some embodiments. The method comprises performing an early close for a plurality of policy holder accounts 610. For each policy holder account, the early close 610 may comprise determining 612 a gain amount for a first investment sub-account 232, determining 614 a maximum participation amount, determining 616 an excess amount for the first investment sub-account, and determining 618 a transfer amount to credit a second investment sub-account from the first investment sub-account. Next, updated information regarding the policy holders, policies and market index values may be received prior to a deadline 620. For each policy holder account, the gain amount for the first investment sub-account, the maximum participation amount, the excess amount and the amount to transfer from the first investment sub-account to the second investment sub-account may be updated based on the updated information 630. In some embodiments, only the policy holder accounts which are affected by the updated information may be updated. For each policy holder account, a portion of the gain and the excess amount may be transferred to the second account prior to a close deadline. For each policy holder account, a purchase order for the next term may be made for at least the first investment sub-account 640. Other steps may be added to the method 600, including receiving periodic updated information, periodically updating the investment account details, receiving additional updated information after a purchase order has been made, and updating the purchase order prior to close for accounts affected by the additional updated information.

The above teachings were described using two sub-accounts (or logical sub-accounts within a single account). It should be understood that similar transfers and account crediting may be made between the second investment sub-account 236 and a third investment sub-account. Different combinations of transfers or crediting between multiple investment sub-accounts (or logical sub-accounts) may also occur.

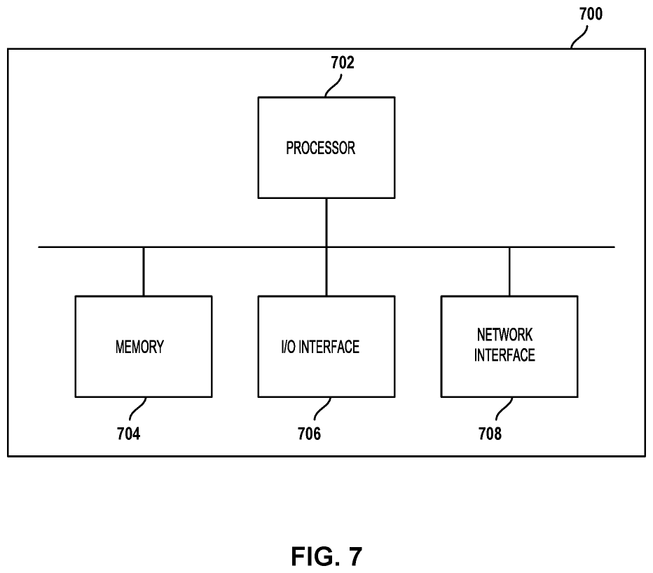

FIG. 7 is a schematic diagram of a computing device 700 such as a server. As depicted, the computing device includes at least one processor 702, memory 704, at least one I/O interface 706, and at least one network interface 708.

Processor 702 may be an Intel or AMD x86 or x64, PowerPC, ARM processor, or the like. Memory 704 may include a suitable combination of computer memory that is located either internally or externally such as, for example, random-access memory (RAM), read-only memory (ROM), compact disc read-only memory (CDROM).

Each I/O interface 706 enables computing device 700 to interconnect with one or more input devices, such as a keyboard, mouse, camera, touch screen and a microphone, or with one or more output devices such as a display screen and a speaker.

Each network interface 708 enables computing device 700 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WMAX), SS7 signaling network, fixed line, local area network, wide area network, and others.

The foregoing discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. An account resource tracking system comprising at least one processor and a memory storing instructions which when executed by the at least one processor configure the at least one processor to:
detect an increase in resources associated with a first account;
allocate a first portion of the increase in resources to a second account;
determine a maximum resource tolerance amount of a remainder of the increase in resources to allocate to the first account;
reallocate the remainder of the remainder of the increase in resources up to the maximum resource tolerance amount into the first account;
determine an excess amount of the remainder that is over the maximum resource tolerance; and
allocate the excess amount to the second account.

2. The account resource tracking system as claimed in claim 1, wherein the at least one processor is configured to obtain at least one of updated policy information or performance index information.

3. The account resource tracking system as claimed in claim 1, wherein the at least one processor is configured to:
determine the increase in resources, the maximum resource tolerance amount and the excess amount at a first time;
obtain at least one of updated policy information or updated performance index information after the first time;
update the increase in resources, the maximum resource tolerance amount and the excess amount based on the updated information; and
update resource allocation instructions based on the updated increase in resources, updated maximum resource tolerance amount and updated excess amount.

4. The account resource tracking system as claimed in claim 1, wherein the at least one processor is configured to:
detect the increase in resources, the maximum resource tolerance amount and the excess amount at a first time;
generate a selection of allocation options based on potential change in value after the first time of at least one of the increase in resources, the maximum resource tolerance amount and the excess amount after the first time;
obtain at least one of updated policy information or updated performance index information after the first time; and
select an allocation option in the selection of allocation options based on the updated information, the allocation option associated with a change in value matching the potential change in value.

5. The account resource tracking system as claimed in claim 1, wherein the maximum resource tolerance amount is defined such that reference underlying exposure of option investments do not represent more than a predetermined percentage of at least one of:
a total account value; or
a credited account value.

6. The account resource tracking system as claimed in claim 5, wherein the maximum resource tolerance amount is determined based on at least one of:
a total of both the first account and the second account; or
a total of credited account values from both the first account and the second account.

7. The account resource tracking system as claimed in claim 1, wherein the at least one processor is configured to obtain at least one of:
the increase in resources;
the maximum resource tolerance amount;
a maximum participation amount percentage value; or
the excess amount.

8. The account resource tracking system as claimed in claim 1, wherein a portion of the amount transferred to the second account is invested in a same hedge position associated with the first account.

9. The account resource tracking system as claimed in claim 1, wherein a plurality of first accounts and a plurality of respective second accounts are tracked such that reallocation for a particular resource are pooled into a batch reallocation order.

10. The account resource tracking system as claimed in claim 1, wherein the at least one processor is configured to:
detect an increase in resources from the second account;
transfer a first portion of the increase in resources from the second account to a third account;
determine a maximum resource tolerance amount of a remainder of the second account increase in resources to reallocate in the second account;
reallocate the remainder of the second account increase in resources up to the second investment account maximum resource tolerance amount into the third account;
determine an excess amount of the second account increase in resources remainder that is over the maximum resource tolerance amount of the second account to the third account; and
transfer the second account excess amount from the second account to the third account.

11. A method of tracking account resources, the method comprising:
detecting an increase in resources associated with a first account;
allocating a first portion of the increase in resources to a second account;
determining a maximum resource tolerance amount of a remainder of the increase in resources to allocate to the first account;
reallocating the remainder of the remainder of the increase in resources up to the maximum resource tolerance amount into the first account;
determining an excess amount of the remainder that is over the maximum resource tolerance; and
allocating the excess amount to the second account.

12. The method as claimed in claim 11, comprising obtaining at least one of updated policy information or performance index information.

13. The method as claimed in claim 11, comprising:
determining the increase in resources, the maximum resource tolerance amount and the excess amount at a first time;
obtaining at least one of updated policy information or updated performance index information after the first time;
updating the increase in resources, the maximum resource tolerance amount and the excess amount based on the updated information; and
updating resource allocation instructions based on the updated increase in resources, updated maximum resource tolerance amount and updated excess amount.

14. The method as claimed in claim 11, comprising:
detecting the increase in resources, the maximum resource tolerance amount and the excess amount at a first time;
generating a selection of allocation options based on potential change in value after the first time of at least one of the increase in resources, the maximum resource tolerance amount and the excess amount after the first time;
obtaining at least one of updated policy information or updated performance index information after the first time;
selecting an allocation option in the selection of allocation options based on the updated information, the allocation option associated with a change in value matching the potential change in value.

15. The method as claimed in claim 11, wherein the maximum resource tolerance amount is defined such that reference underlying exposure of option investments do not represent more than a predetermined percentage of at least one of:
a total account value; or
a credited account value.

16. The method as claimed in claim 15, wherein the maximum resource tolerance amount is determined based on at least one of:
a total of both the first account and the second account; or
a total of credited account values from both the first account and the second account.

17. The method as claimed in claim 11, comprising obtaining at least one of:
the increase in resources;
the maximum resource tolerance amount;
a maximum participation amount percentage value; or
the excess amount.

18. The method as claimed in claim 11, wherein a portion of the amount transferred to the second account is invested in a same hedge position associated with the first account.

19. The method as claimed in claim 11, wherein a plurality of first accounts and a plurality of respective second accounts are tracked such that reallocation for a particular resource are pooled into a batch reallocation order.

20. The method as claimed in claim 11, comprising:
detecting an increase in resources from the second account;
transferring a first portion of the increase in resources from the second account to a third account;
determining a maximum resource tolerance amount of a remainder of the second account increase in resources to reallocate in the second account;
reallocating the remainder of the second account increase in resources up to the second investment account maximum resource tolerance amount into the third account;
determining an excess amount of the second account increase in resources remainder that is over the maximum resource tolerance amount of the second account to the third account; and
transferring the second account excess amount from the second account to the third account.
